(19) United States
(12) Patent Application Publication
(10) Pub. No.: US 2017/0365194 A1
(43) Pub. Date: Dec. 21, 2017

(54) METHOD OF TRACKING AND ASSOCIATING PERSONAL AND HISTORICAL INFORMATION REGARDING A PIECE OF JEWELRY

(71) Applicants: Hasmukh Dholakiya, North Bergen, NJ (US); Hasmukh Dholakiya, North Bergen, NJ (US)

(72) Inventors: Hasmukh Dholakiya, North Bergen, NJ (US); Hasmukh Dholakiya, North Bergen, NJ (US)

(21) Appl. No.: 15/631,601

(22) Filed: Jun. 23, 2017

Related U.S. Application Data
(63) Continuation of application No. 12/910,200, filed on Oct. 22, 2010.

(51) Int. Cl. G09F 3/00; G06Q 30/06

(52) U.S. Cl. CPC G09F 3/00; G06Q 30/0601

(57) ABSTRACT

A method of tracking and associating personal and historical information regarding a piece of jewelry, having the steps of receiving a rough diamond, assigning a diamond identification code and capturing an image of the rough diamond; cut, polish and laser inscribe the diamond identification code on the rough diamond by a specific craftsmen to provide a polished diamond and specific craftsmen data and capturing an image of the polished diamond; obtaining a third party diamond certification; design a setting for the polished diamond by a design craftsmen; capturing an image of the completed set diamond ring; the above information is saved in a computing system and associated with the diamond identification code.

This application is a continuation of application Ser. No. 12/910,200 filed Oct. 22, 2010 and entitled “Jewelry System and Method for Selling a Piece of Jewelry by Including a Story of the Piece.” The present invention relates generally to jewelry and selling of jewelry and, more particularly, to selling pieces of jewelry that include gemstones.

### BACKGROUND OF THE INVENTION

### 1—Field of the Invention

### 2—Description of Related Art

Gemstones, such as diamonds, rubies, emeralds, sapphires, turquoises, semi-precious stones and the like, may each come from various mines or sources and may each be subjected to various processes before they reach the body of the person owning them and wearing them.

Conventionally, a piece of jewelry including a gemstone is sold to a customer based on the specifications of the jewelry and particularly the specifications of the gemstone. More recently, because of the heightened social awareness regarding the ills associated with the so-called “blood diamonds,” some merchants advertise their diamonds as “conflict-free diamonds” in order to put the customer's conscience at ease. Generally, aside from these limited types of information, no other history or story is provided to customer.

A diamond ring is a sentimental piece of jewelry. Historical information about the piece has an increased importance. The purchaser and/or wearer of the piece would like to know information such as wherein the diamond was mined, the weight of the diamond when it was mined, a picture of the rough diamond, where and by whom the diamond was polished, when and where the ring was made, where and by whom the ring was designed. The wearer may want to know more information than a standard piece of jewelry. The purchaser wants to feel there piece of jewelry is unique and special, just as in the story of their engagement and wedding. The present invention solves the problem of tracking and providing the historical information regarding the diamond from the mine, to the design of the ring setting and the craftsmen involved. It also solves the problem of tracking, storing and allowing the purchaser(s) and/or wearer(s) to associate personal information such as the engagement story and the wedding story with the item of jewelry. Finally, it allows third parties to add their stories regarding engagements and weddings and/or subsequent purchasers.

### SUMMARY OF THE INVENTION

Aspects of the present invention provide systems and methods for selling jewelry pieces that include gemstones. The systems and methods of the aspects of the present invention, improve upon the experience of buying and owning a piece of jewelry by including the true source of the gemstone that is set in the piece of jewelry and the story behind the formation of the gemstone and the manufacture of the piece. The systems and methods of the present invention may further provide registration for the piece. The registration serves to authenticate the piece. Systems and methods of the present invention, thus, help increase both monetary value and sentimental value of a piece of jewelry by providing credible information to the buyer regarding the sources of the material and the labor that have contributed to the finished product and by allowing the buyer to include his or her personal story that led to the purchase of the piece. This information may be preserved in a database that is made available to potential second hand and third hand buyers of the piece.

Aspects of the present invention provide a method of tracking and associating personal and historical information regarding a piece of jewelry, the method comprising: receiving a rough diamond having rough diamond data, wherein rough diamond data includes at least the country of origin and weight; assigning a diamond identification code to the rough diamond; capturing an image of the rough diamond; saving the image of the rough diamond, the rough diamond data and the diamond identification code in a computing system; cut, polish and laser inscribe the diamond identification code on the rough diamond by a specific craftsmen to provide a polished diamond and specific craftsmen data, wherein the specific craftsmen data includes at least location, date and name; capturing an image of the polished diamond, including at least the laser inscription and the polished diamond; saving the image of the polished diamond and the specific craftsmen data in a computing system and associating the image of the polished diamond and the specific craftsmen data with the diamond identification code in the computing system; obtaining a third party diamond certification and associating the third party diamond certification with the diamond identification code and saving the third party diamond certification with the diamond identification code in a computing system; design a setting for the polished diamond by a design craftsmen and engrave at least the diamond identification code, the diamond weight and metal identification on the inside band of a ring setting to provide a completed set diamond ring; capturing an image of the completed set diamond ring; saving design craftsmen data and the image of the completed set diamond ring in a computing system and associate the design craftsmen data and the image of the completed set diamond ring with the diamond identification code.

The information tag may be physically associated with the piece of jewelry. The diamond identification code may be selected from a number, a name, an alphanumeric string, a bar code and a radio frequency identification code. In various aspects of the present invention the jewelry system may further include a website having an address included on the information tag, and a server serving the website and including storage media for storing information entered at the website. The website permits registration of the piece of jewelry at the website, and additional information regarding the piece of jewelry entered to the website is stored at the server and remains associated with the piece of jewelry. The registration of the piece of jewelry and the additional information regarding the piece of jewelry may be made available to a seller and a buyer of the piece of jewelry and to third parties referring to the website. The third parties may include heirs of the buyer who inherit the piece of jewelry and future buyers who buy from the buyer. The identification code may be placed on some of the parts forming the piece of jewelry including the setting and the gemstone and the registration of the piece of jewelry at the website certifies authenticity of the parts that include the identification code. More than one piece or one type of gemstone may be used in the piece.

Aspects of the present invention provide a method of selling jewelry where the jewelry includes a setting and a gemstone. The method includes providing the jewelry to a customer together with an information tag associated with the jewelry, the information tag reciting a story of the jewelry, the story including origins of and processes performed on the gemstone and the setting leading to manufacture of the jewelry as presented to the customer, and providing a website to the customer for registration of the jewelry, the website permitting the customer to enter personal information regarding purchase and use of the jewelry in order to personalize the story. The jewelry and the information tag are associated and have a one to one relationship, the information tag uniquely identifying the jewelry.

In various aspects of the present invention, the method may further include one or more of manufacturing the information tag to recite the story, manufacturing the jewelry, establishing the website and storing the story on a storage medium in communication with the website, associating the information tag with the jewelry via an identification code included on the information tag and on the jewelry, providing access to the story on the website for family and friends of the customer and future buyers of the jewelry from the customer, and certifying authenticity of the jewelry on the website for future buyers of the jewelry from the customer. The access to the story for the family, the friends and the future buyers may be provided via the identification code. In one aspect, the access to the story for the family, the friends and the future buyers may be provided via information regarding the gemstone, the setting or a current owner of the jewelry.

In one aspect of the present invention, successive owners of the jewelry are identified on the website and stories of successive owners of the jewelry is provided on the website.

Aspects of the present invention further provide a method of personalized registration of jewelry pieces that includes establishing a website for the registration, providing a server accessible from the website where the server is used for storing information associated with the jewelry pieces, providing access to a purchaser of a piece of jewelry to register the piece at the website, providing permission to the purchaser to add a personal story regarding the piece to the website, providing access to the information associated with the piece to a first group of visitors to the website, and providing access to the personal story to a second group of visitors to the website. The first group includes potential second-hand buyers of the piece, the second group includes friends and family of the purchaser, and the first group and the second group may overlap.

The booklet and the registration website together serve as a birth certificate plus a passport for the piece of jewelry. They show where the jewelry came from and where has it been since it was born. Moreover, if the owners care to enter their stories at the website, pictures and stories of the various journeys that the jewelry has taken, for example the various owners it has had and why they purchased it and what their lives were about, are added to the birth certificate and the passport.

### BRIEF DESCRIPTION OF THE DRAWINGS

FIG. 1 shows a jewelry system including a piece of jewelry and an associated information booklet, according to aspects of the present invention.

FIG. 2 shows a registration system, according to aspects of the present invention, associated with the jewelry system of FIG. 1.

FIG. 3 shows a flowchart of a method of selling jewelry, according to aspects of the present invention.

FIG. 4 shows a front cover view of a jewelry information booklet, according to aspects of the present invention.

FIG. 5 shows a back cover view of the jewelry information booklet of FIG. 4, according to aspects of the present invention.

FIG. 6 shows an insert view of the jewelry information booklet of FIG. 4, according to aspects of the present invention.

FIG. 7 shows a front view of a counter stand booklet, according to aspects of the present invention.

FIG. 8 depicts a page of a sample page of an informational booklet according to the present invention.

FIG. 9 depicts information regarding the rough diamond in the informational booklet.

FIG. 10 depicts the rough mapping of the rough diamond in the informational booklet.

FIG. 11 depicts the rough cutting and polishing in the informational booklet.

FIG. 12 depicts a diamond grading page in the informational booklet.

FIG. 13 depicts a diamond ring design page in the informational booklet.

FIG. 14 depicts a diamond setting page in the informational booklet.

FIG. 15 depicts a wedding page in the informational booklet.

FIG. 16 depicts a birth certificate according to the present invention.

FIG. 17 depicts an information card according to the present invention.

FIG. 18 depicts the diamond identification code, the diamond weight and metal identification on the inside band of a ring setting providing a completed set diamond ring.

FIG. 19 depicts a polished diamond with a laser inscription.

FIG. 20 depicts packaging according to the present invention.

FIG. 21 depicts a card holder slot for holding an information card.

### DETAILED DESCRIPTION OF THE INVENTION

Aspects of the present invention provide systems and methods for selling jewelry. The jewelry that is sold according to the aspects of the present invention includes one or more gemstones placed in a setting, which is typically a ring. The gemstones may include diamonds, rubies, sapphires, emeralds, turquoises or other types of precious or semi-precious stones.

The systems and methods of the aspects of the present invention, improve upon the experience of buying and owning a piece of jewelry by including the true source of the gemstone that is set in the piece of jewelry, the story behind the formation of the gemstone, the story behind the manufacture of the setting that holds the gemstone, and the story of the fabrication of the overall piece in general.

Systems and methods of the present invention, thus, help increase the monetary value of a piece of jewelry by providing credible information to the owner regarding the sources of the material and the labor that have contributed to the finished product. The sentimental value of the piece is also increased when the source and origin of the piece is identified to be conflict free. The sentimental value may be further increased by adding the personal story of the purchaser to the information that is associated with the piece.

The systems and methods of the present invention further provide registration for the piece. Registration would preserve the information regarding the piece in a database that may be made available to potential second hand and third hand buyers of the piece. Registration permits the buyers to include their personal story at a registration website. The personal story provides context to friends and family of the owner if the piece is a symbolic piece of jewelry such as a wedding ring or an anniversary gift. The personal story also remains associated with the jewelry for future generations that may inherit the jewelry. Registration further serves to authenticate the piece for future buyers if a current buyer decides to sell the jewelry at a later point in time.

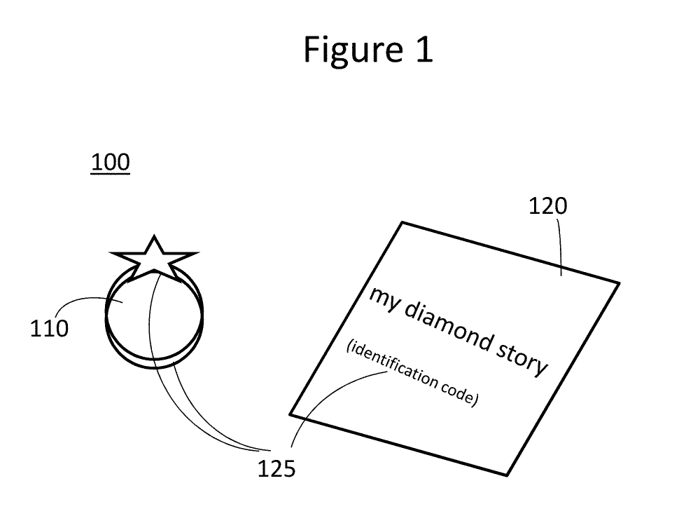

FIG. 1 shows a jewelry system including a piece of jewelry and an associated information booklet, according to aspects of the present invention.

FIG. 1 shows system 100 that includes a diamond ring 110 and an information booklet 120 associated with the ring. The diamond ring is packaged and sold with the information booklet.

The ring 110 is exemplary and other pieces of jewelry which include precious stones may equally serve as a part of the jewelry system 100.

The information booklet 120 may be a pamphlet or a brochure made from paper, plastic, leather, glass, metal or another material capable of being written upon. The information booklet may also be an electronic book or made from electronic paper.

In the system 100, the ring 110 and the information booklet are associated with an identification code 125 that establishes a unique one to one correlation between the two. Thus, the information booklet of one ring is not replaceable with the information booklet of another ring.

The identification code may be an RFID code, a bar code, a number, an alphanumeric string such as a name or some other similar means capable of uniquely identifying an object. The identification code may be placed on just the setting that houses the gemstones or it may be placed on all various parts of the piece of jewelry. If the identification code is later used as a means for certifying the authenticity of the piece of jewelry, all or some of the various parts of the piece may be required to include the code. A piece of jewelry that includes several gemstones on a setting may derive its value from one or more of the gemstones or from the finished product that combines all of the gemstones in a particular arrangement within the setting. In one aspect of the present invention, the parts of the jewelry that contribute the most to its value are marked by the code. In another aspect, and depending on the number and size of the parts, all of the parts may be marked by the code.

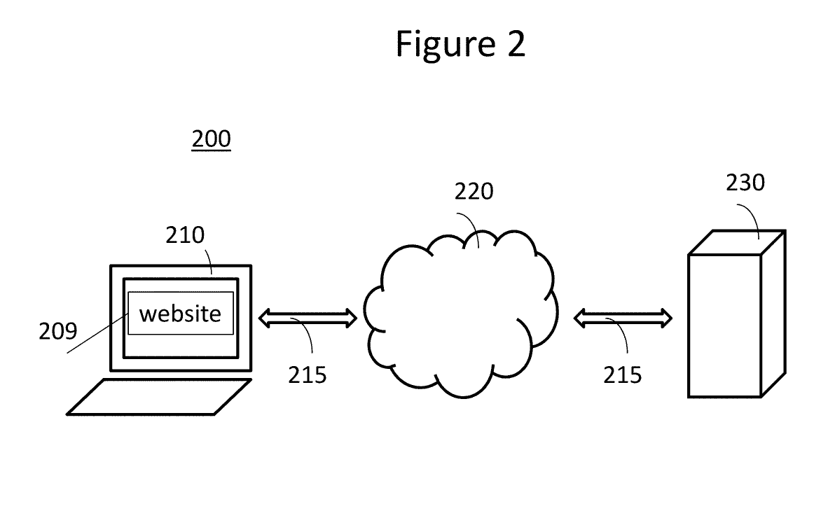

FIG. 2 shows a registration system, according to aspects of the present invention, associated with the jewelry system of FIG. 1.

FIG. 2 shows the registration system 200 including a registration station 210 and a registration server 230 that are coupled together via the internet 220. Communications 215 between the registration station 210 and the registration server 230 with the internet 220 may be wired or wireless. Moreover, the registration station 210 and the registration server 230 may be directly connected without an intermediary. The registration station 210 may be a station set up at the jewelry store or a personal computer of the buyer. The registration server may be rented or owned and is controlled by a central management.

For example, a buyer of the jewelry system 100 of FIG. 1 uses the information available in the information booklet 120 to register his ring 110 at the registration server 230 by accessing the registration website from his personal computer which operates as the registration station 210.

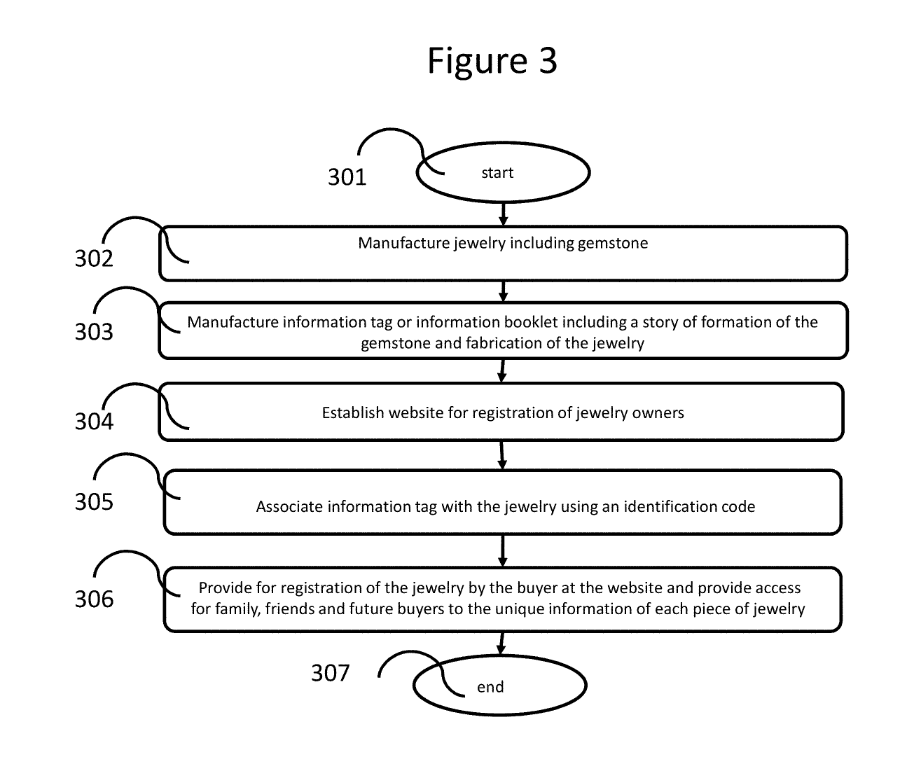

FIG. 3 shows a flowchart of a method of selling jewelry, according to aspects of the present invention.

At 301, the method begins. At 302, the jewelry is manufactured. The jewelry includes a setting and one or more gemstones.

At 303, an information booklet or information tag is prepared that includes the specific information of the jewelry manufactured at 302. In one aspect of the present invention, the entity who prepares the information tag obtains the material that is included in the information tag from the manufacturer of the jewelry. If the information in the tag is to be used for registration and authentication of the jewelry that is associated with the tag, then the entity who prepares the tag has to assure itself that the information provided by the manufacturer is true and correct.

At 304, a website is established for registration of the jewelry owners. The website leads to storage media for storing the information provided in each information tag.

At 305, the information tag is associated with the piece of jewelry to which it pertains. The information tag is either physically attached to the piece of jewelry or a unique identification code associates the two in a one to one correlation. Using a unique identification code prevents the loss of the one to one relationship when the ring is separated from the tag or booklet in order to be worn.

At 306, the website or the registration station provides for registration of the information available in the information tag at the storage media of the registration station. The website also allows access by potential second-hand buyers, friends and family and future generations who may inherit the jewelry. Access for third party onlookers such as second hand buyers, friends and family may be set up such that it requires permission by the owner. Access may be set up such that it is public and searchable by various parameters including the specifications of the jewel, name of the manufacturer or the name of the owner. Registration at the website may serve as authentication for the jewelry such that the information pertaining to a specific identification may provide certification of authenticity for the identified jewelry. At 307, the method ends.

When different entities perform the various steps of the above method, they each provide assurances for the following entity that the information is true and accurate.

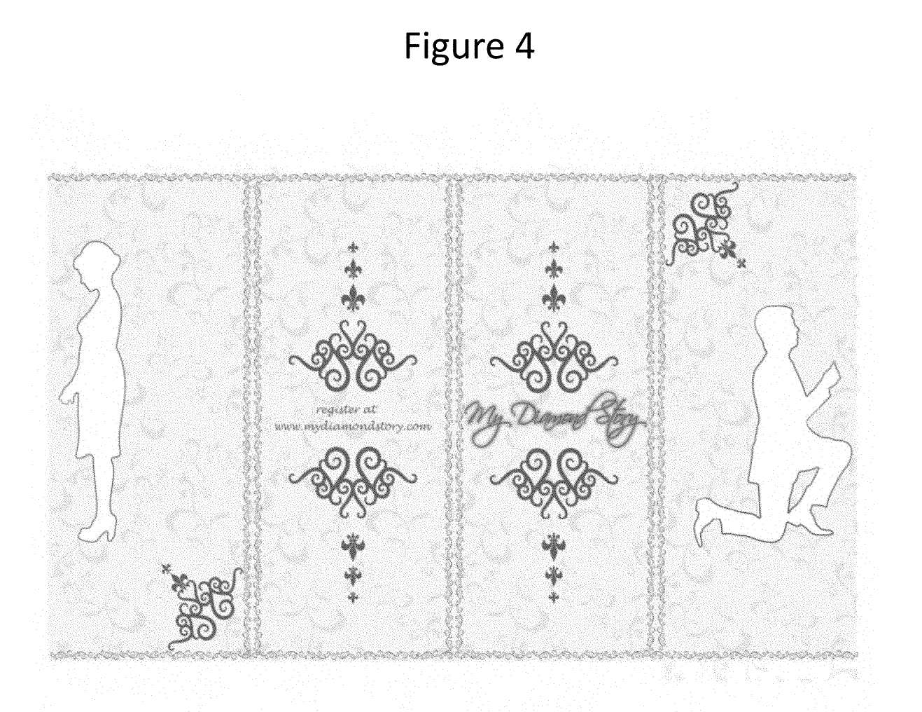

FIG. 4 shows a front cover view of a jewelry information booklet, according to aspects of the present invention.

In FIG. 4 an exemplary information tag or information booklet associated with a diamond ring is depicted. The booklet has the caption “My Diamond Story” and informs the owner that he may register at www.mydiamondstoy.com.

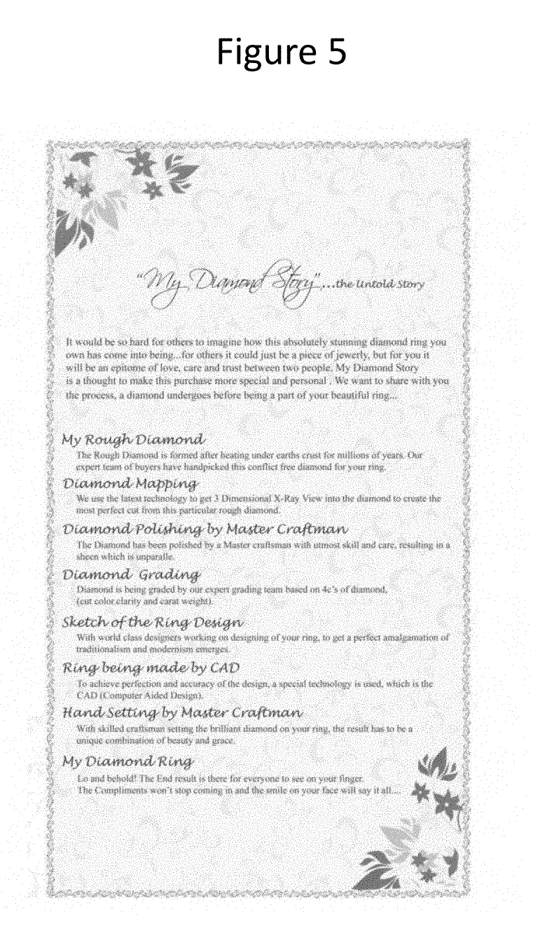

FIG. 5 shows a back cover view of the jewelry information booklet of FIG. 4, according to aspects of the present invention.

FIG. 5 shows the back cover of an exemplary information tag or booklet such as the exemplary booklet shown in FIG. 4. The back cover explains how including the booklet with the ring makes the purchase more personal. The booklet explains the story and a history of the diamond from the mine to the ring of the person wearing the ring. The exemplary booklet shown, lists the headings: My Diamond, Diamond Mapping, Diamond Polishing by Master Craftsmen, Diamond Grading, Sketch of the Ring Design, Ring Being Made By CAD, Handsetting by Master Craftsmen, and finally My Diamond Ring.

The headings and the contents are changed to match the gemstone and the piece of jewelry if other than a diamond and a ring. Under the heading “My Diamond,” the booklet explains that the diamond is formed under the heat and pressure of the earth's crust and after millions of years. Under this heading, it is also specified that the particular diamond is conflict free. Under the heading “Diamond Mapping,” the type of technology for evaluating the diamond to determine a suitable cut for it is specified. For example, 3D X-ray technology may be used to look through the diamond and find the cut that suits the particular diamond. Under the heading “Diamond Polishing by Master Craftsmen,” it is explained that a craftsman has to polish the diamond to achieve a perfect sheen. Under the heading “Diamond Grading,” it is explained that the particular diamond is graded by the craftsmen based on cut, color, clarity, and carat weight which make up the 4 Cs of diamond. Under the heading “Sketch of the Ring Design,” it is explained that the design of the setting or ring is by master designers. Under the heading “Ring Being Made By CAD,” it is explained that the setting or the ring is actually made by computer aided design machinery using CAD-CAM technology. Under the heading “Handsetting by Master Craftsmen,” it is explained that craftsmen have to set the diamond on the ring. Finally, under the heading “My Diamond Ring,” it is declared that after the placing of the gemstone into the setting, the ring is complete.

The diamond story shown in FIG. 5 may include more or less detail depending on context.

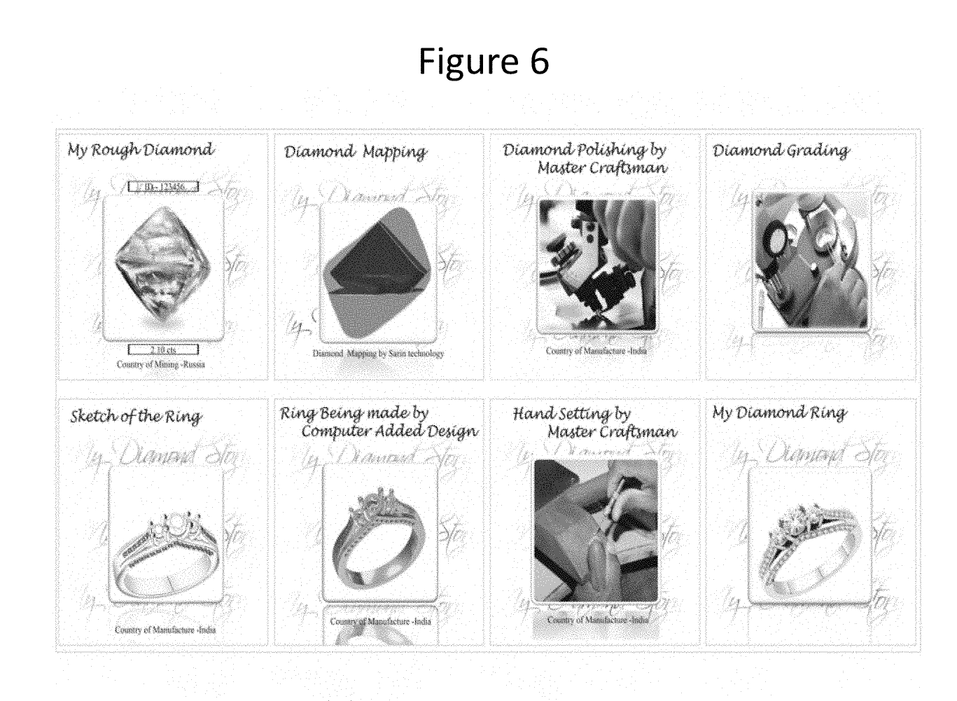

FIG. 6 shows an insert view of the jewelry information booklet of FIG. 4, according to aspects of the present invention.

FIG. 6 includes pictorial depictions of the stages or headings that are shown in FIG. 5. In FIG. 6, the weight of the diamond in carats and its particular identification code or identification number are shown. FIG. 6 includes particulars regarding each of the steps of making the ring such as the origin of the diamond, the country of design and manufacture of the setting and the finished product as well as the particular technology used for each of the steps such as mapping, polishing, and grading.

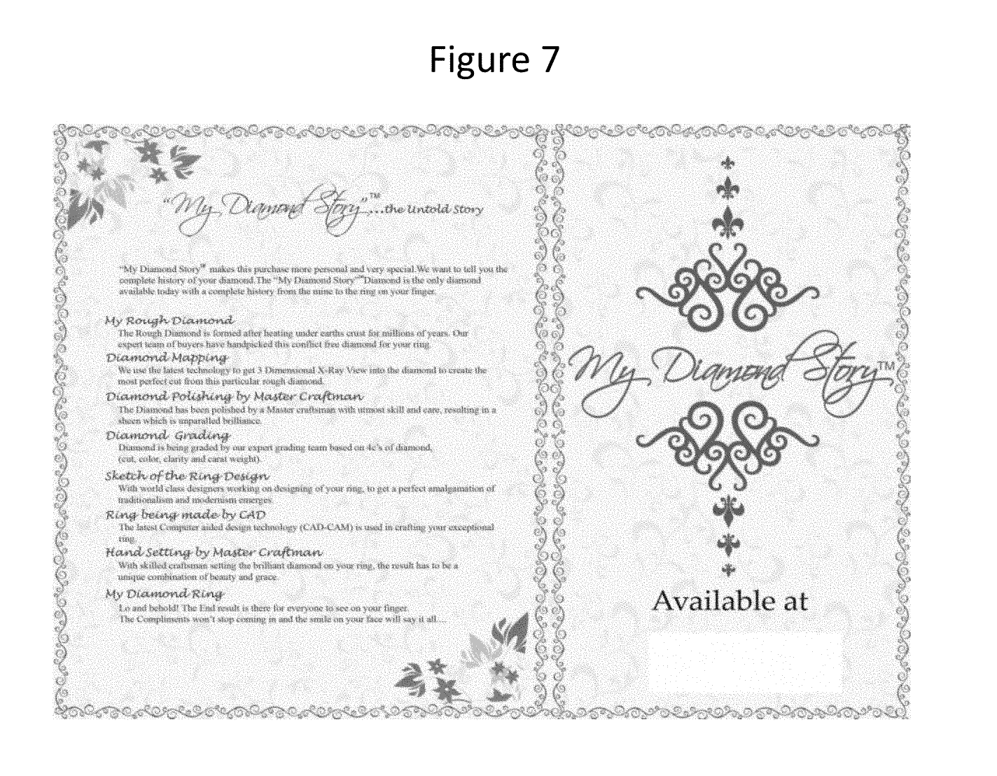

FIG. 7 shows a front view of a counter stand booklet, according to aspects of the present invention.

The counter stand booklet shown in FIG. 7 repeats the information on the back of the information booklet as shown in FIG. 5. The counter stand information is general and may only include the headings and information that is common to all products sold in association with the information booklet. Each particular ring has its own particular identification and information that may be included only in the particular information tag or booklet that is associated with the ring.

Thus, a combination of the information booklet and the additional material that is entered into the registration website provide a birth certificate and a passport for the piece, showing how and where it was born and where has it traveled since being born. Each step in the method and system may be implemented by a computer, microprocessor, or a network of computers, and information (including the information tag) may be stored on a database, a network of computers and/or any other computer readable storage medium.

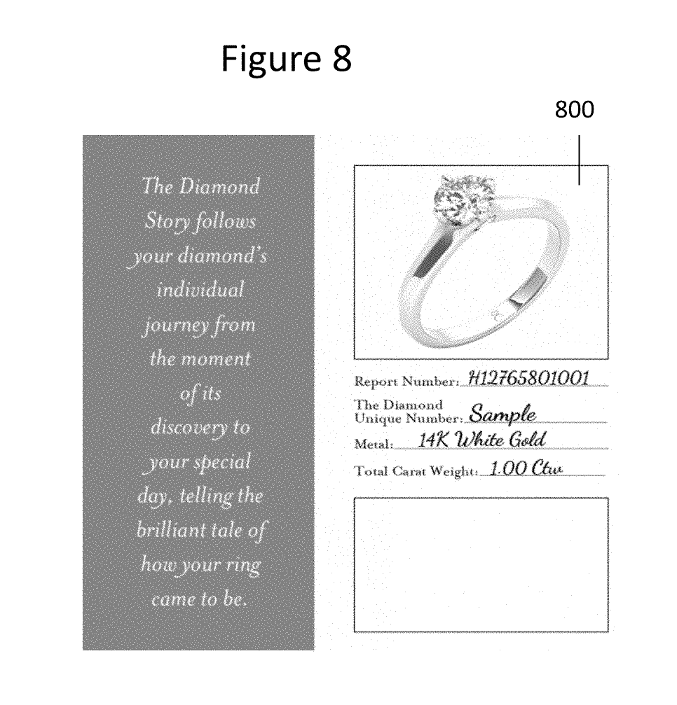

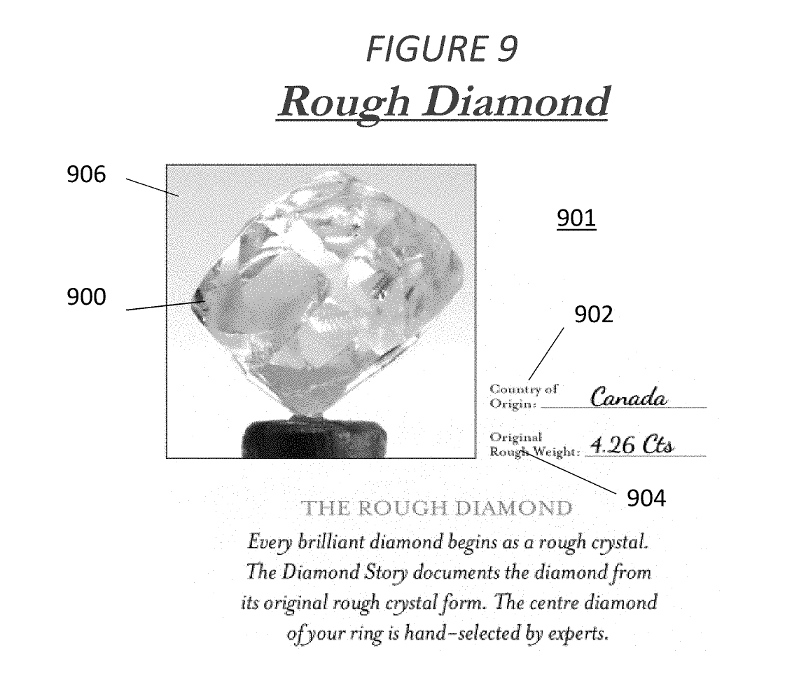

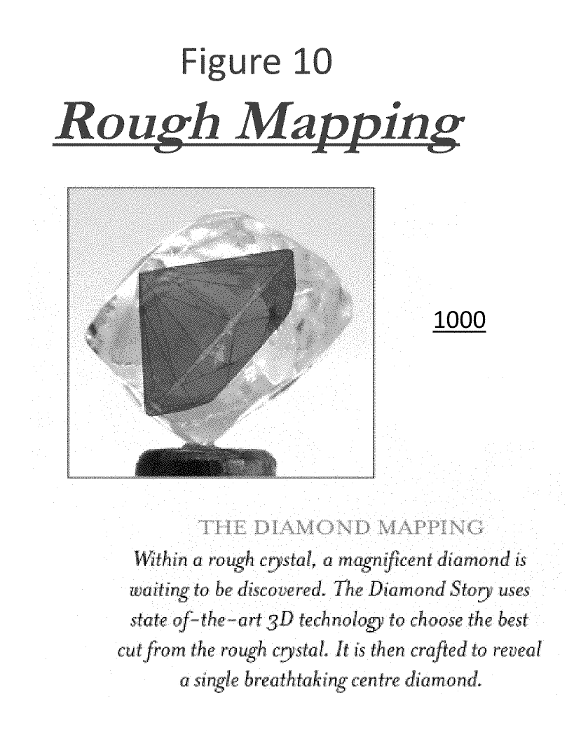

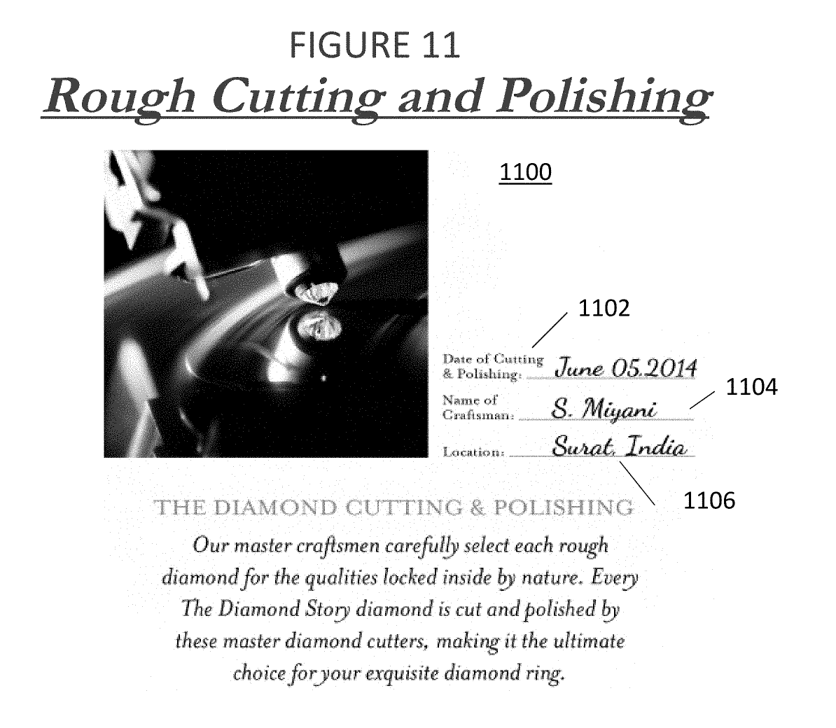

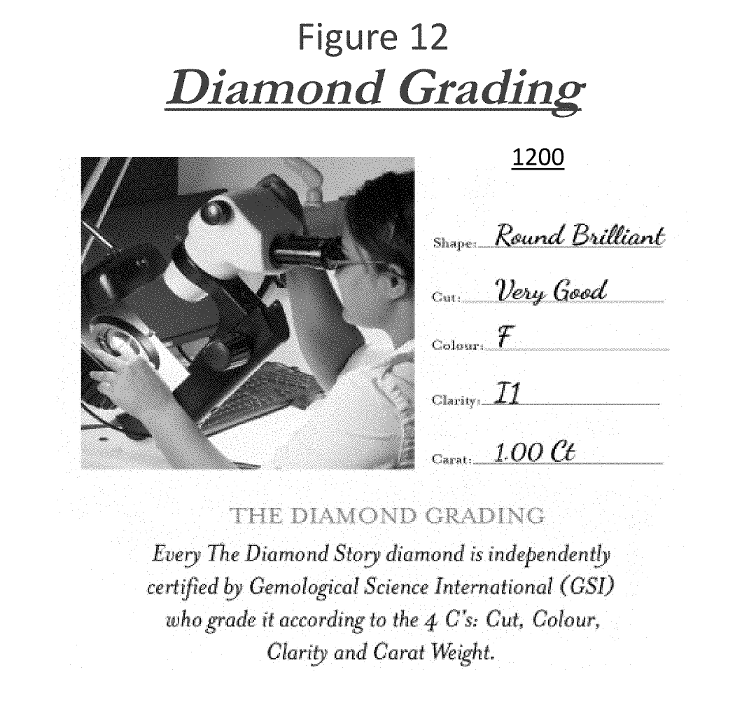

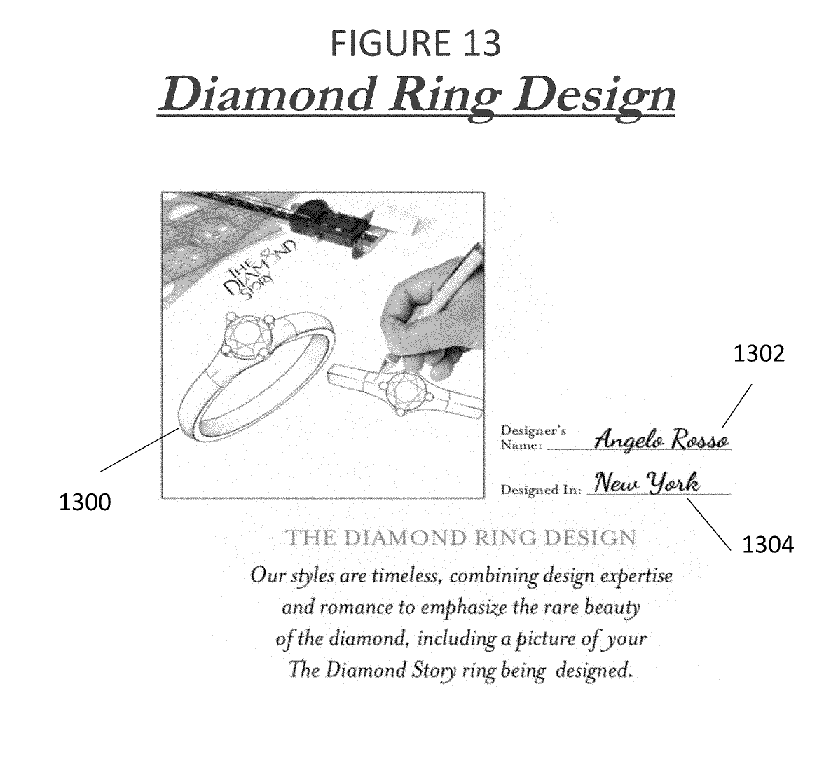

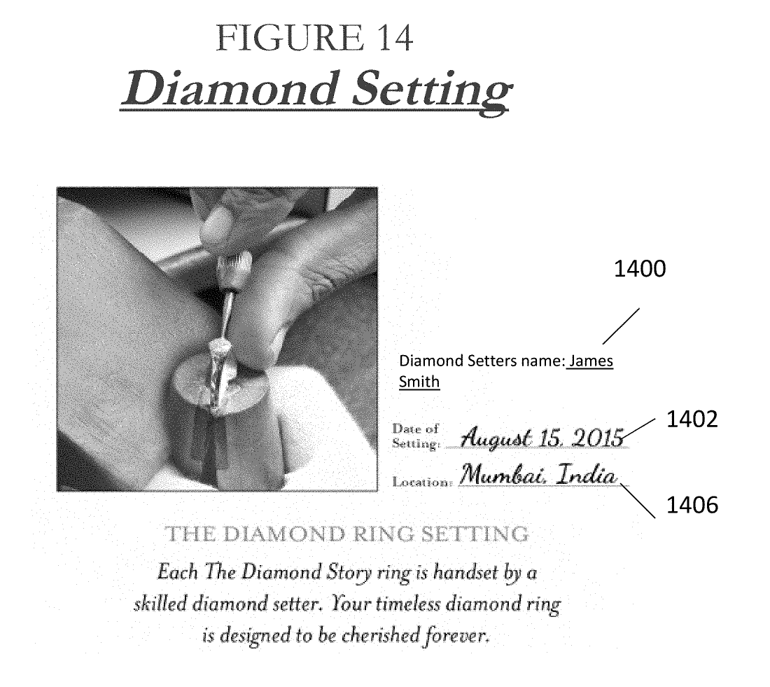

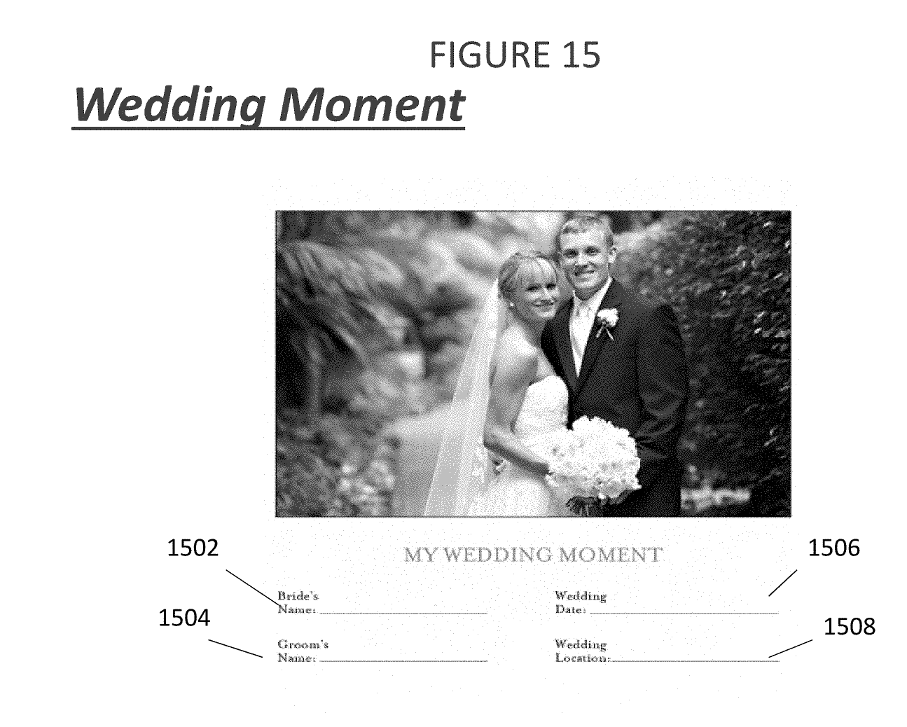

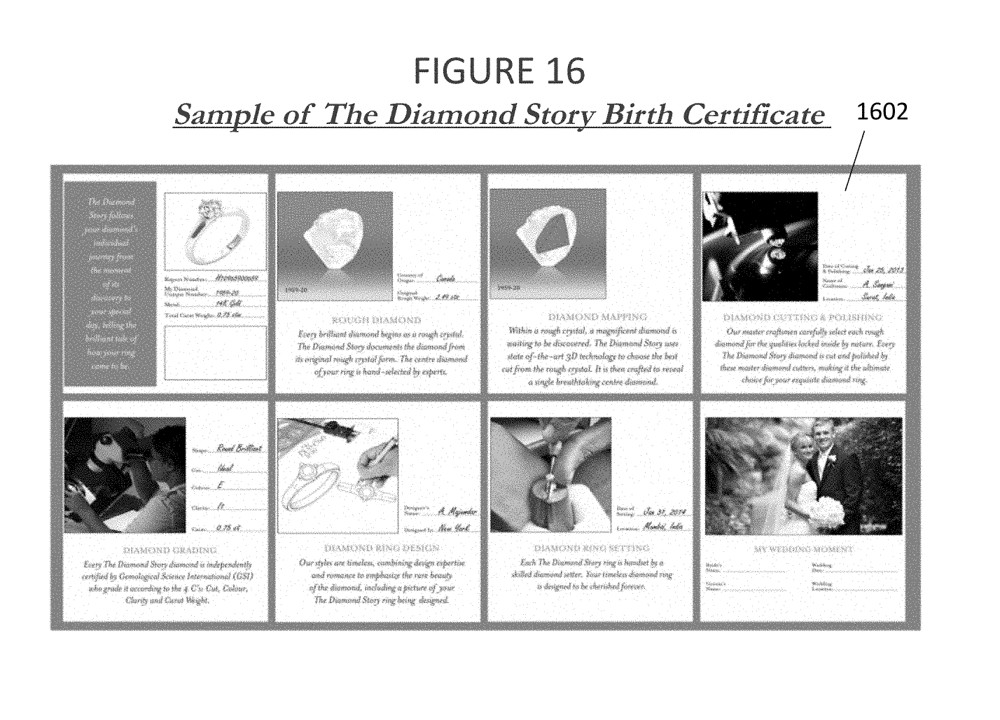

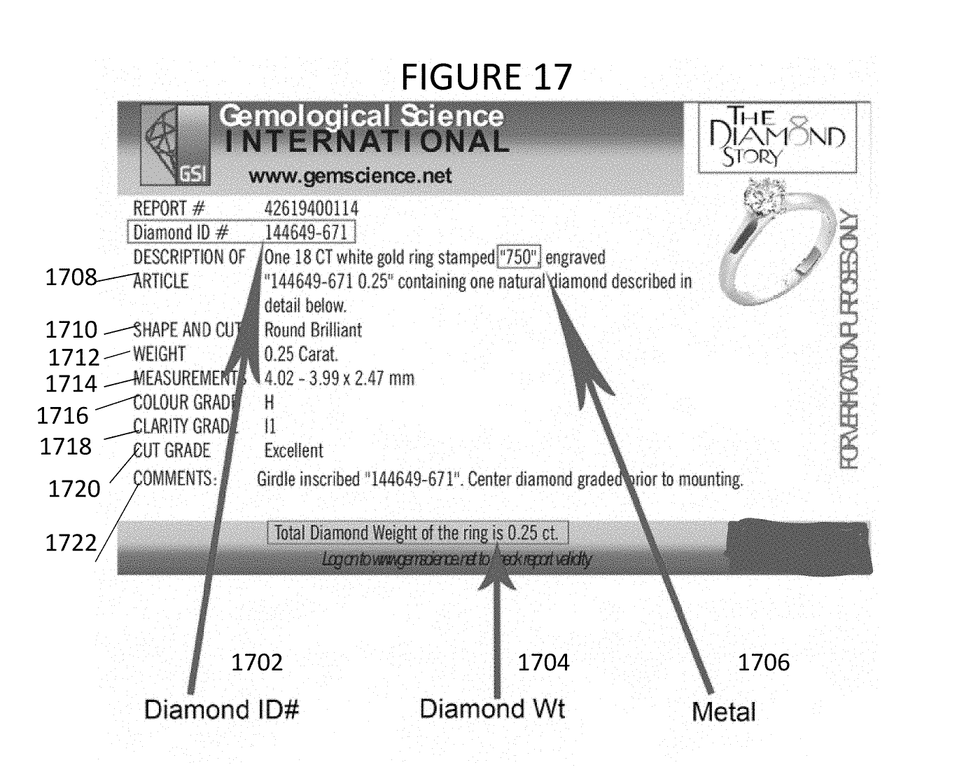

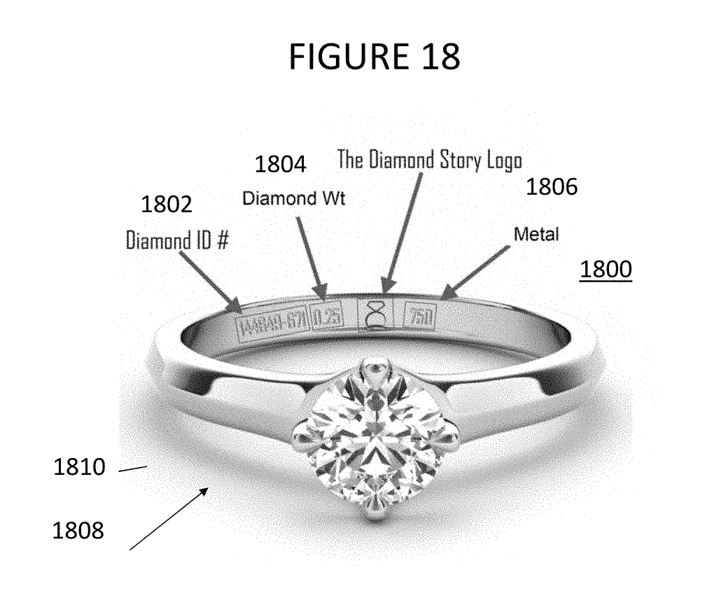

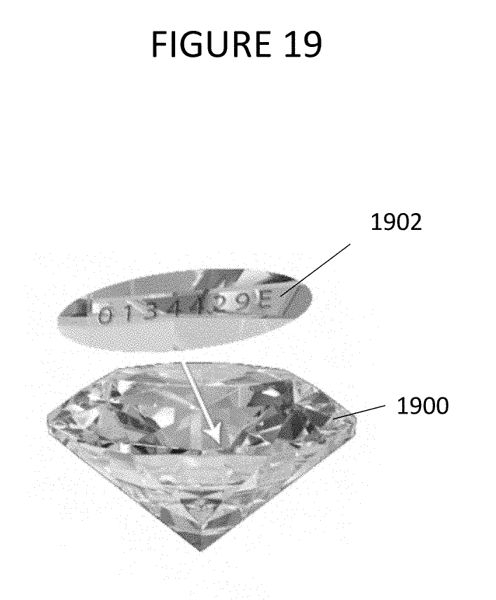

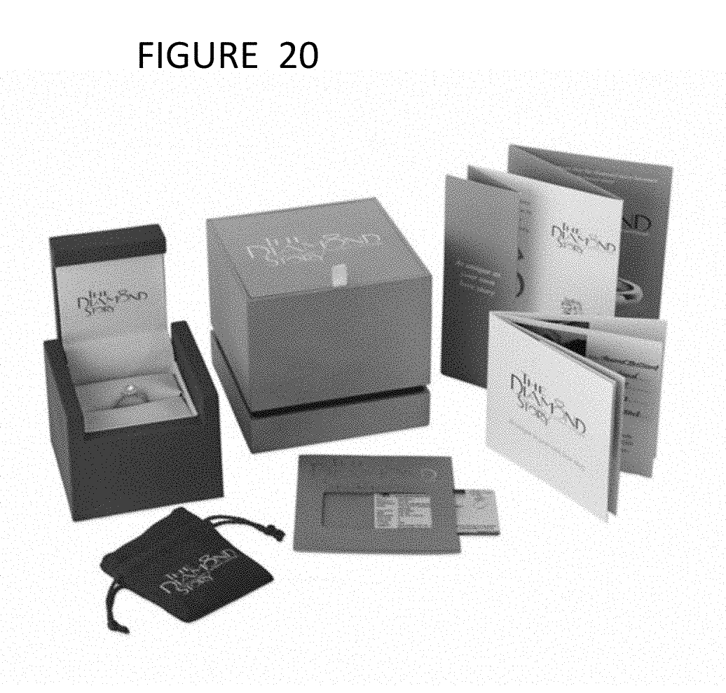

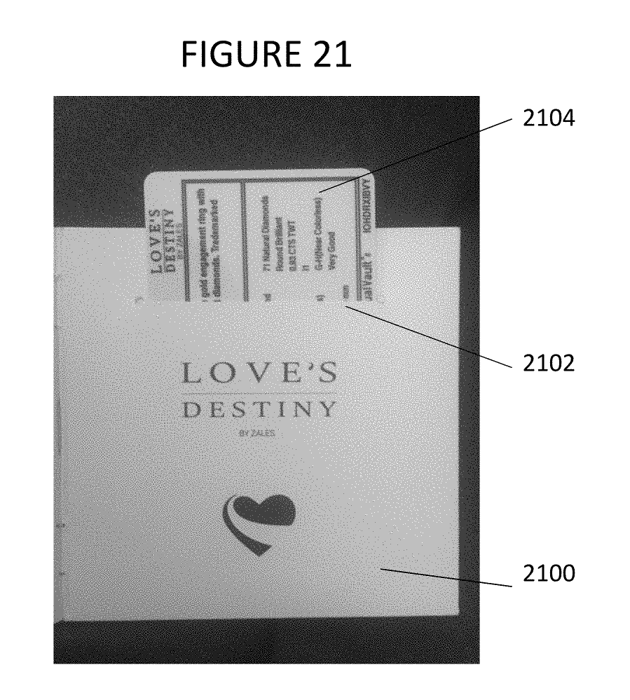

With reference to FIGS. 8-21, a method of tracking and associating personal and historical information regarding a piece of jewelry (800), the method comprising: receiving a rough diamond (900) having rough diamond data, wherein rough diamond data includes at least the country of origin (902) and weight (904). The rough diamond data may further include the name of the diamond mine, the name of the individual who discovered the rough diamond and a conflict free certification. The method may have the step of assigning a diamond identification code (1802) to the rough diamond; capturing an image (906) of the rough diamond; saving the image (906) of the rough diamond, the rough diamond data and the diamond identification code (1802) in a computing system (e.g. 210); cut, polish and laser inscribe the diamond identification code (1802) on the rough diamond by a specific craftsmen to provide a polished diamond and specific craftsmen data, wherein the specific craftsmen data includes at least location (1106), date (1102) and name (1104); capturing an image of the polished diamond (1900), including at least the laser inscription (1902) and the polished diamond (1900); saving the image of the polished diamond and the specific craftsmen data in a computing system (e.g. 210) and associating the image of the polished diamond (1900) and the specific craftsmen data with the diamond identification code (1802) in the computing system. There may be the step of grading the polished diamond to provide an internal diamond grade; saving the internal diamond grade in a computing system; and associating the internal diamond grade with the diamond identification code (1802). There may further be the step of obtaining a third party diamond certification and associating the third party diamond certification with the diamond identification code (1802) and saving the third party diamond certification with the diamond identification code in a computing system. There may be the step of designing a setting (1300) for the polished diamond by a design craftsmen (1302) and engrave at least the diamond identification code (1802), the diamond weight (1804) and metal identification (1806) on the inside band of a ring setting to provide a completed set diamond ring (1808); capturing an image (1810) of the completed set diamond ring (1808); saving design craftsmen data (e.g. designers name (1302) and location (1304)) and the image (1810) of the completed set diamond ring (1808) in a computing system and associate the design craftsmen data and the image of the completed set diamond ring with the diamond identification code (1802). It is noted that the design craftsmen data may include more than one craftsmen. For example, as shown in FIG. 13, there may be a designers name (1302) and location (1304), which may be different from the person who set the diamond, diamond setters name (1400), with a different date of setting (1402) and location (1406). This may all be saved as design craftsmen data. The design craftsmen data may be the name(s), location(s), date of design(s), date range of design(s), design story and photos of the craftsmen(s) designing and making the polished diamond. There may be the step of providing a birth certificate (1602) for the completed diamond ring set.

There may be the step of providing a website to a customer, the website permitting the customer to enter personal information regarding purchase and use of the jewelry in order to personalize the story, wherein the personal information is associated with the diamond identification code. The personal information may include the bride's name (1502), groom's name (1504) engagement story, the engagement date, the engagement location, the wedding story, the wedding date (1506), the wedding location (1508), engagement photos and wedding photos.

There may be an informational booklet, wherein the informational booklet contains a rough diamond page (901), a diamond mapping page (1000), a diamond cutting and polishing page (1100), a diamond grading page (1200), a completed set diamond image page and a card holder slot (2102) for holding an information card (2104). The information card (2104) may be placed in the card holder slot (2102), wherein the information card (2104) is associated with the completed set diamond ring by the diamond identification code (1802). The information card (1700) may contain information such as the diamond identification code (1702), diamond weight (1704), metal (1706) description of article (1708), shape and cut (1710), weight (1712), measurements (1714), color grade (1716), clarity grade (1718), cut grade (1720) and comments (1722). The diamond identification code is unique to the individual diamond. A diamond setting may contain numerous gemstones. The diamond identification code may be laser inscribed on each of the gemstones or only the center or main gemstone without departing from the present invention. In the event the diamond identification code is laser inscribed on each of the gemstones, it would still be one unique diamond identification code. The diamond identification code may be a number, a name, an alphanumeric string, a bar code and a radio frequency identification code.

The personal information may be made available to a seller and a buyer of the piece of jewelry and to third parties referring to the website (209) and granted access. Authorized sellers, buyers and third parties may add story information associated with the diamond identification code (1702). Registration of the piece of jewelry at a website (209) may certify authenticity of the parts that include the identification code.

The rough diamond data, the image of the rough diamond, the diamond identification code, the specific craftsmen data. The image of the polished diamond, an internal diamond grade, the third party diamond certification, the image of the completed set diamond ring, the design craftsmen data and the personal story may be stored on a storage medium (230) in communication with the website (209). Access to the personal story for the family, the friends and the future buyers may be provided by invitation through the website (209). This information may be public or private, as elected by the user and may be linked through social media. Successive owners of the completed set diamond ring may be identified on the website (209) and personal stories of the successive owners may be provided on the website (209).

The present invention has been described in relation to particular examples, which are intended to be illustrative rather than restrictive, with the scope and spirit of the invention being indicated by the following claims and their equivalents.

1. A method of tracking and associating personal and historical information regarding a piece of jewelry, the method comprising:
receiving a rough diamond having rough diamond data, wherein rough diamond data includes at least the country of origin and weight;
assigning a diamond identification code to the rough diamond;
capturing an image of the rough diamond;
saving the image of the rough diamond, the rough diamond data and the diamond identification code in a computing system;
cut, polish and laser inscribe the diamond identification code on the rough diamond by a specific craftsmen to provide a polished diamond and specific craftsmen data, wherein the specific craftsmen data includes at least location, date and name;
capturing an image of the polished diamond, including at least the laser inscription and the polished diamond;
saving the image of the polished diamond and the specific craftsmen data in a computing system and associating the image of the polished diamond and the specific craftsmen data with the diamond identification code in the computing system;
design a setting for the polished diamond by a design craftsmen and engrave at least the diamond identification code, the diamond weight and metal identification on the inside band of a ring setting to provide a completed set diamond ring;
capturing an image of the completed set diamond ring;
saving design craftsmen data and the image of the completed set diamond ring in a computing system and associate the design craftsmen data and the image of the completed set diamond ring with the diamond identification code.

2. A method as in claim 1, further comprising the steps of:
providing a website to a customer, the website permitting the customer to enter personal information regarding purchase and use of the jewelry in order to personalize the story, wherein the personal information is associated with the diamond identification code.

3. A method as in claim 2, wherein the personal information is selected from the group comprising the engagement story, the engagement date, the engagement location, the bride's name, the groom's name, the wedding story, the wedding date, the wedding location, engagement photos and wedding photos.

4. A method as in claim 1, wherein the rough diamond data further includes the name of the diamond mine, the name of the individual who discovered the rough diamond and a conflict free certification.

5. A method as in claim 1, wherein the design craftsmen data is selected from the group comprising the name, location, date of design, date range of design, design story and photos of the craftsmen designing and making the polished diamond.

6. A method as in claim 1, further comprising;
providing an informational booklet, wherein the informational booklet contains a rough diamond page, a diamond mapping page, a diamond cutting and polishing page, a diamond grading page, a completed set diamond image page and a card holder slot for holding an information card.

7. A method as in claim 6, further comprising the steps of:
providing an information card to be placed in the card holder slot, wherein the information card is associated with the completed set diamond ring by the diamond identification code.

8. A method as in claim 7, wherein the information card contains information selected from the group consisting of diamond identification code, quantity, shape, weight, clarity, color, cut, measurements, history of formation and processing of the gemstone, a history of design and fabrication of the setting, conflict free certification and a history of manufacture of the piece of jewelry.

9. A method as in claim 1, further comprising the steps of obtaining a third party diamond certification and associating the third party diamond certification with the diamond identification code and saving the third party diamond certification with the diamond identification code in a computing system;

10. A method as in claim 1, wherein the diamond identification code is selected from the group consisting of a number, a name, an alphanumeric string, a bar code and a radio frequency identification code.

11. A method as in claim 2, wherein the personal information is made available to a seller and a buyer of the piece of jewelry and to third parties referring to the website and granted access.

12. A method as in claim 11, wherein authorized sellers, buyers and third parties may add story information associated with the diamond identification code.

13. A method as in claim 1, wherein registration of the piece of jewelry at a website certifies authenticity of the parts that include the identification code.

14. The method of claim 2,
wherein at least one of the rough diamond data, the image of the rough diamond, the diamond identification code, the specific craftsmen data. The image of the polished diamond, an internal diamond grade, the third party diamond certification, the image of the completed set diamond ring, the design craftsmen data and the personal story are stored on a storage medium in communication with the website.

15. The method of claim 1, wherein access to the personal story for the family, the friends and the future buyers is provided by invitation through the website.

16. The method of claim 2, wherein successive owners of the completed set diamond ring are identified on the website, and wherein personal stories of the successive owners are provided on the website.

17. The method of claim 1, further comprising the steps of:
grading the polished diamond to provide an internal diamond grade;
saving the internal diamond grade in a computing system; and
associating the internal diamond grade with the diamond identification code.

18. The method of claim 1, further comprising the steps of:
providing a birth certificate for the completed diamond ring set.
